(19) United States
(12) Patent Application Publication
(10) Pub. No.: US 2017/0167411 A1
(43) Pub. Date: Jun. 15, 2017

(54) VARIABLE VALVE APPARATUS

(71) Applicant: Hyundai Motor Company, Seoul (KR)

(72) Inventor: Gisoo HYUN, Hwaseong-si (KR)

(73) Assignee: Hyundai Motor Company, Seoul (KR)

(21) Appl. No.: 15/297,759

(22) Filed: Oct. 19, 2016

(30) Foreign Application Priority Data
Dec. 10, 2015 (KR) 10-2015-0176346

(51) Int. Cl. F02D 13/02; F02D 41/00

(52) U.S. Cl. CPC F02D 13/0253; F02D 41/009

(57) ABSTRACT

A variable valve apparatus may include a crank position sensor sensing a position of a crank shaft, a plurality of valves selectively opening or closing a combustion chamber in a cylinder, a hydraulic pump supplying a hydraulic pressure or a hydraulic flow, servo valves controlling the hydraulic pressure or hydraulic flow supplied from the hydraulic pump according to the position of the crank position, sensed by the crank position sensor, actuators operating the valves by the hydraulic pressure or hydraulic flow supplied from the servo valves, and a controlling outputting a control signal that controls an open amount and open time of the servo valves according to a position of the crank shaft.

### CROSS-REFERENCE TO RELATED APPLICATION

The present application claims priority to and the benefit of Korean Patent Application No. 10-2015-0176346 filed on Dec. 10, 2015, the entire contents of which is incorporated herein for all purposes by this reference.

### BACKGROUND OF THE INVENTION

Field of the Invention

The present invention relates to a variable valve apparatus. More particularly, the present invention relates to an electric variable valve apparatus.

Description of Related Art

An internal combustion engine generates power by burning fuel in a combustion chamber in an air media that is drawn into the chamber. Intake valves are operated by a camshaft in order to take in the air, and the air is drawn into the combustion chamber while the intake valves are open. In addition, exhaust valves are operated by the camshaft, and a combustion gas is exhausted from the combustion chamber while the exhaust valves are open.

An optimal operation of the intake valves and the exhaust valves depends on a rotation speed of the engine. That is, optimal opening/closing timing of the valves or an optimal lift depends on the rotation speed of the engine.

In order to achieve such an optimal valve operation depending on the rotation speed of the engine, research has been undertaken on an optimal valve operation. For example, a variable valve lift (VVL) apparatus implemented so as for the valve to operate as different lifts according to the RPM, and a variable valve timing (VVT) apparatus opening/closing the valves with appropriate timing according to the RPM have been researched and developed.

Such a VVL apparatus or VVT apparatus is typically driven by the camshaft using a hydraulic pressure generated from a hydraulic pump of an engine. An apparatus that controls opening/closing timing of the valve or a left of the valve by the camshaft is called a mechanical variable valve apparatus.

However, a conventional mechanical variable valve apparatus has a complicated structure and a large volume, thereby deteriorating designing freedom of an engine room. In addition, due to the complicated structure of the mechanical variable valve apparatus, manufacturing cost of a vehicle is increased, responding speed becomes slow, and opening/closing timing of the valve and patterns of the valve lift cannot be variously implemented.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a variable valve apparatus having a new structure for implementation of a simple structure, fast responding speed, various valve timing, lift, and duration.

A variable valve apparatus according to an exemplary embodiment of the present invention includes: a crank position sensor sensing a position of a crank shaft; a plurality of valves selectively opening or closing a combustion chamber in a cylinder; a hydraulic pump supplying a hydraulic pressure or a hydraulic flow; servo valves controlling the hydraulic pressure or hydraulic flow supplied from the hydraulic pump according to the position of the crank position, sensed by the crank position sensor; actuators operating the valves by the hydraulic pressure or hydraulic flow supplied from the servo valves; and a controlling outputting a control signal that controls an open amount and open time of the servo valves according to a position of the crank shaft.

The open amount and open time of the servo valve may be respectively controlled according to intensity and a waveform width of the control signal output from the controller.

The actuators may include: actuator housings to which the hydraulic pressure or hydraulic flow is introduced through the servo valves; and operation rods provided in the actuator housings, operating according to the hydraulic pressure or hydraulic flow introduced into the actuator housings, and respectively connected with the plurality of valves.

The variable valve apparatus may further include a position sensor sensing positions of the operation rods of the actuators.

The controller may compensate the control signal from the positions of the operation rods, sensed by the position sensor.

The controller may calculate a position error of the plurality of valves from the positions of the actuators, sensed by the position sensor and the position of the crank shaft, sensed by the crank position sensor, and may output the control signal after making the position error zero.

The plurality of valves may include: an intake valve being selectively opened/closed for supplying air and fuel to the combustion chamber; and an exhaust valve being selectively opened/closed to discharge exhaust gas generated from the combustion chamber.

The hydraulic pump may include: a hydraulic storage storing oil; a pump pumping oil stored in the hydraulic storage; and a hydraulic motor operating the pump.

The variable valve apparatus according to the above-stated exemplary embodiment of the present invention can be realized as an electric variable valve apparatus so that a simple structure, fast responding speed, and various valve timing and lift can be realized.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view of a configuration of a variable valve apparatus according to an exemplary embodiment of the present invention.

FIG. 2 is a graph illustrating a control signal according to the exemplary embodiment of the present invention.

FIG. 3, FIG. 4, FIG. 5, FIG. 6 and FIG. 7 are graphs illustrating a valve lift of the variable valve apparatus according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Because the size and thickness of each configuration shown in the drawings are arbitrarily shown for better understanding and ease of description, the present invention is not limited thereto, and the thicknesses of portions and regions are exaggerated for clarity.

Hereinafter, a variable valve apparatus according to an exemplary embodiment of the present invention will be described in detail with reference to the accompanying drawings.

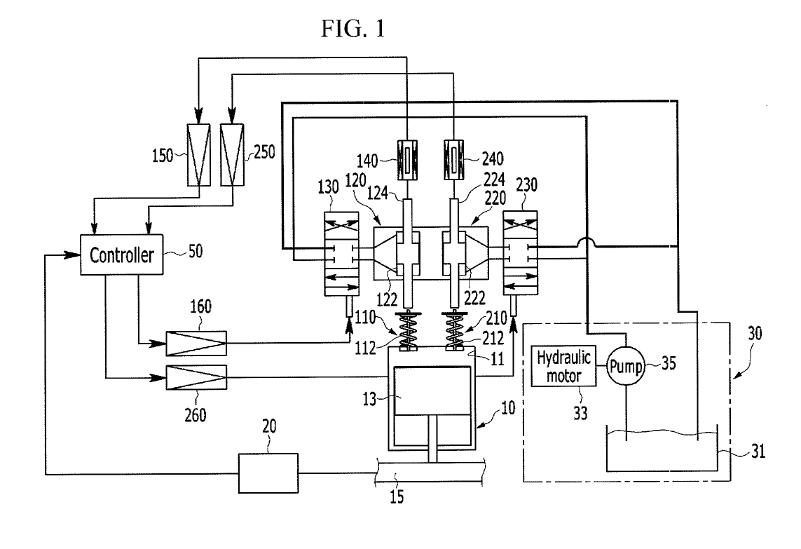

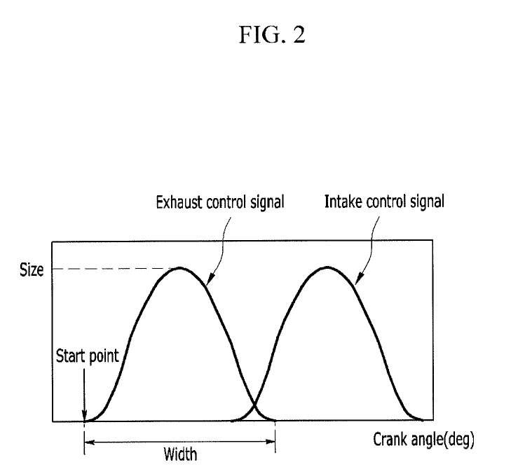

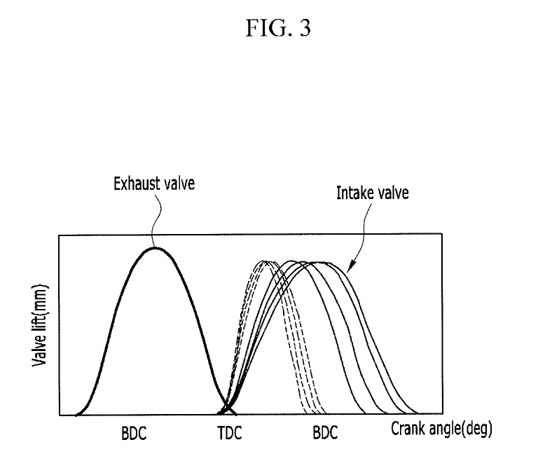

FIG. 1 is a schematic view of a configuration of a variable valve apparatus according to an exemplary embodiment of the present invention.

As shown in FIG. 1, a variable valve apparatus according to an exemplary embodiment of the present invention includes a crank position sensor 20, a plurality of valves 110 and 210, a hydraulic pump 30, servo valves 130 and 230, actuators 120 and 220, and a controller 50.

The crank position sensor 20 senses a position and the speed of a crank shaft 15, and the sensed position and speed of the crank shaft 15 are transmitted to the controller 50.

A piston 13 is connected through a connecting rod to the crank shaft 15, and the crank shaft 15 rotates as the piston 13 reciprocates in the combustion chamber 11 of the cylinder 10. Thus, a position and speed of the piston 13 can be calculated from the position and speed of the crank shaft 15.

The plurality of valves 110 and 210 include an intake valve 110 that selectively opens or closes the combustion chamber 11 in order to supply air and fuel (diesel or gasoline) into the combustion chamber 11 and an exhaust valve 210 that selectively opens or closes the combustion chamber 11 in order to discharge exhaust gas generated from the combustion chamber 11 to the outside.

The intake valve 110 and the exhaust valve 210 are respectively provided with valve springs 112 and 222, and the valve springs 112 and 222 provide elastic force in a direction to which the combustion chamber 11 of the cylinder 10 is closed by the intake valve 110 and the exhaust valve 210. That is, in a normal state, the intake valve 110 or the exhaust valve 210 maintains the combustion chamber 11 of the cylinder 10 in the closed state by the valve springs 112 and 222.

In the exemplary embodiment of the present invention, the valve springs 112 and 222 are exemplarily described as coil springs, but this is not restrictive. In addition, in the exemplary embodiment of the present invention, each of the intake valve 110 and the exhaust valve 210 is singly provided, but this is not restrictive.

The hydraulic pump 30 is provided for driving the actuators 120 and 220 by supplying a hydraulic pressure or a hydraulic flow to the servo valves 130 and 230, and includes a hydraulic storage 31, a hydraulic motor 33, and a pump 35.

The hydraulic storage 31 stores oil supplied to the servo valves 130 and 230.

The hydraulic motor 33 is driven with a predetermined rotation speed (RPM) according to a control signal applied from the controller 50 to operate the pump 35 connected by the rotation shaft such that the amount of oil discharged from the pump 35 is controlled.

In the exemplary embodiment of the present invention, the hydraulic pressure or hydraulic flow is supplied to the servo valves 130 and 230 from an electric hydraulic pump 30, but this is not restrictive.

The servo valves 130 and 230 operate the actuators 120 and 220 by controlling the hydraulic pressure or hydraulic flow supplied from the hydraulic pump 30.

The actuators 120 and 220 are respectively connected with the intake valve 110 and the exhaust valve 210, and are driven by the hydraulic pressure or hydraulic flow supplied through the servo valves 130 and 230 to operate the intake valve 110 and the exhaust valve 210.

That is, the actuators 120 and 220 may be formed of actuator housings 122 and 222 and operation rods 124 and 224 provided in the actuator housings 122 and 222. The operation rods 124 and 224 are respectively connected with the intake valve 110 and the exhaust valve 210.

The operation rods 124 and 224 perform vertical movement according to the hydraulic pressure or hydraulic flow supplied into the actuator housings 122 and 222, and the intake valve 110 and the exhaust valve 210 selectively open or close the inside of the combustion chamber 11 while vertically moving according to the movement of the operation rods 124 and 224. When the intake valve 110 is opened, air and fuel are supplied into the combustion chamber 11, and when the exhaust valve 210 is opened, exhaust gas generated from the combustion chamber 11 is discharged to the outside of the combustion chamber 11.

In this case, the amount of movement of the operation rods 124 and 224 is controlled according to the quantity of hydraulic pressure or hydraulic flow introduced into the actuator housings 122 and 222. For example, as the quantity of the hydraulic pressure of hydraulic flow introduced into the actuator housings 122 and 222 is increased, the amount of movement of the operation rods 124 and 224 may be increased.

The controller 50 outputs a control signal for controlling an open amount and open time of the servo valves 130 and 230 according to a position of the crank shaft 15, sensed by the crank position sensor 20. The control signal may be a voltage value or a current value transmitted to the servo valves 130 and 230.

The controller 50 may be provided as at least one of processors operated by a predetermined program, and the predetermined program is set to perform each step of a method for controlling the variable valve apparatus according to the exemplary embodiment of the present invention.

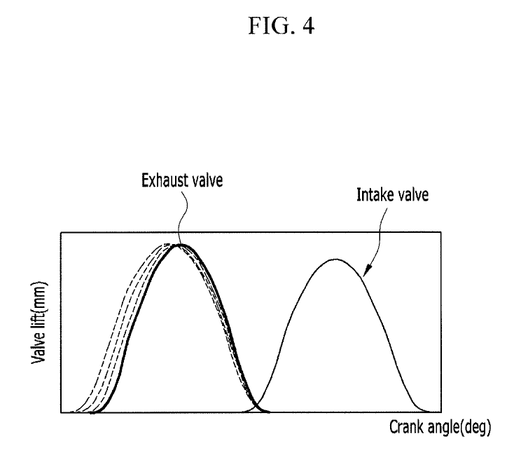

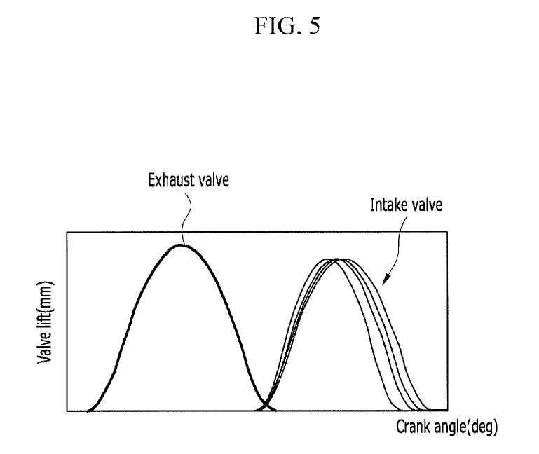

The control signal generated and output from the controller 50 may have a specific waveform so as to control the open amount and the open time of the servo valves 130 and 230. For example, as shown in FIG. 2, the control signal may be generated in the shape of a sine waveform and then output. Alternatively, the control signal may be generated in the shape of a pulse waveform as necessary.

The variable valve apparatus may further include a servo amplifier that amplifies the control signal output from the controller 50. The servo amplifier amplifies a voltage value or a current value output from the controller 50 and transmits the amplified value to the servo valves 130 and 230.

The open amount of the servo valves 130 and 230 may be controlled according to the intensity of the control signal (i.e., current value or voltage value).

For example, when the current value or the voltage value is high, the open amount of the servo valves 130 and 230 is increased, and then the hydraulic pressure or hydraulic flow supplied to the actuators 120 and 220 through the servo valves 130 and 230 is increased such that the open amount of the intake valve 110 and the exhaust valve 210 is increased.

On the contrary, when the current value or voltage value is low, the open amount of the servo valves 130 and 230 is decreased and thus the hydraulic pressure or hydraulic flow supplied to the actuators 120 and 220 through the servo valves 130 and 230 is decreased such that the open amount of the intake valve 110 and the exhaust valve 210 is decreased.

In addition, the open time of the intake valve 110 and the exhaust valve 210 can be controlled according to a waveform width of the control signal. For example, when the waveform width of the control signal is wide, the open time of the servo valves 130 and 230 is extended and thus time for supplying the hydraulic pressure of hydraulic flow to the actuators 120 and 220 through the servo valves 130 and 230 is also extended such that the open time of the intake valve 110 and the exhaust valve 210 is extended.

On the contrary, when the waveform width of the control signal is narrow, the open time of the servo valves 130 and 230 is shortened and thus time for supplying the hydraulic pressure or hydraulic flow to the actuators 120 and 220 is shortened such that the open time of the intake valve 110 and the exhaust valve 210 is shortened.

Meanwhile, the variable valve apparatus according to the exemplary embodiment of the present invention may further include position sensors 140 and 240 that sense positions of the actuators 120 and 220, more particularly, positions of the operation rods 124 and 224. The position sensors 140 and 240 may be differential transformer sensor (DTF) sensors. However, this is not restrictive, and the position sensors 140 and 240 may be provided as other sensors that can sense positions of the operation rods 124 and 224.

The position sensors 140 and 240 sense positions of the operation rods 124 and 224 of the actuators 120 and 220 connected with the intake valve 110 and the exhaust valve 210, and transmit the sensed positions of the operation rods 124 and 224 of the actuators 120 and 220 to the controller 50 via the converters 150 and 250.

The controller 50 calculates a position error of the intake valve 110 and the exhaust valve 210 from the positions of the operation rods 124 and 224 sensed by the position sensors 140 and 240 and positions of the crank shaft 15 sensed by the crank position sensor 20, and compensates the control signal to make the position error zero and outputs the compensated control signal.

That is, the controller 50 determines a position of the piston 13 from the rotation position of the crank shaft 15, sensed by the crank position sensor 20. In addition, the controller 50 generates a control signal that controls an open amount and an open time of the servo valves 130 and 230 so as to open or close the intake valve 110 and the exhaust valve 210 corresponding to the rotation position of the crank shaft 15.

However, an error may occur in operations of the servo valves 130 and 230 that operate by the control signal, and accordingly, the position of the intake valve 110 and the position of the exhaust valve 210 may not precisely track positions according to the control signal.

Thus, the controller 50 senses positions of the operation rods 124 and 224 from the position sensors 140 and 240, and determines a position of the intake valve 110 and a position of the exhaust valve 210 from the positions of the operation rods 124 and 224. In addition, the controller 50 compares locations according to the control signal with substantial positions of the operation rods 124 and 224 to calculate a position error of the intake valve 110 and the exhaust valve 210, and compensates the control signal to make the position error zero and outputs the compensated control signal.

The control signal is compensated as described above through the position sensors 140 and 240, thereby enabling accurate position control of the intake valve 110 and the exhaust valve 210.

Hereinafter, operation of the variable valve apparatus according to the exemplary embodiment of the present invention will be described in detail.

First, the crank position sensor 20 senses a position and speed of the crank shaft 15, and the sensed position and speed of the crank shaft 15 are transmitted to the controller 50.

The controller 50 generates a control signal (current valve or voltage value) according to the position and speed of the crank shaft 15 and outputs the generated control signal to the servo valves 130 and 230.

The servo valves 130 and 230 operate according to the control signal such that the amount of the hydraulic pressure or hydraulic flow and time for supplying the hydraulic pressure or hydraulic flow to the actuator housings 122 and 222 can be controlled.

The hydraulic pressure or hydraulic flow supplied from the hydraulic pump 30 through the servo valves 130 and 230 is supplied into the actuator housings 112 and 222, and the operation rods 124 and 224 provided in the actuator housings 122 and 222 vertically move according to the hydraulic pressure or hydraulic flow supplied to the actuator housings 122 and 222.

That is, when no hydraulic pressure or hydraulic flow is supplied to the actuator housings 122 and 222 through the servo valves 130 and 230 from the hydraulic pump 30, the operation rods 124 and 224 do not operate and are positioned in a normal state (i.e., the operation rods 124 and 224 are positioned in an upper side. In addition, the intake valve 110 or the exhaust valve 210 connected to the operation rods 124 and 224 maintains the combustion chamber 11 in a closed state by the valve spring.

However, when the hydraulic pressure or hydraulic flow is supplied to the actuator housings 122 and 222 from the hydraulic pump 30 through the servo valves 130 and 230, the operation rods 124 and 224 move downward and the intake valve 110 or the exhaust valve 210 connected to the operation rods 124 and 224 move downward such that the combustion chamber 11 is opened.

In this case, the open time of the servo valves 130 and 230 is controlled according to a waveform width of the control signal, and an open amount of the servo valves 130 and 230 is controlled according to intensity of the control signal. According to the open amount and open time of the servo valves 130 and 230, a supply amount and a supply time of the hydraulic pressure or hydraulic flow supplied to the actuator housings 122 and 222 are controlled.

In addition, movement distances and movement time of the operation rods 124 and 224 are controlled according to the supply amount and the supply time of the hydraulic pressure or hydraulic flow supplied to the actuator housings 122 and 222, and accordingly, a movement distance and movement time of the intake valve 110 or the exhaust valve 210 connected to the operation rods 124 and 224 are controlled.

That is, a lift of the intake valve 110 and the exhaust valve 210 is controlled according to intensity of the control signal, duration of the intake valve 110 and the exhaust valve 210 is controlled according to the waveform width of the control signal, and opening/closing timing of the intake valve 110 and the exhaust valve 210 is controlled according to a start point of the control signal. In addition, an overlap of the intake valve and the exhaust valve can be controlled by properly controlling the start point and the waveform width of the control signal.

For example, when the waveform width of the control signal is wide, open time of the servo valves 130 and 230 is extended, and accordingly, an open time of the intake valve 110 or the exhaust valve 210 is extended. That is, since the open time of the servo valves 130 and 230 is extended, open time of the intake valve 110 or the exhaust valve 210 is extended. That is, duration of the intake valve 110 or the exhaust valve 210 is extended.

On the contrary, when the waveform width of the control signal is narrow, the open time of the servo valves 130 and 230 is shortened and accordingly the open time of the intake valve 110 or the exhaust valve 210 is shortened. That is, since the open time of the servo valves 130 and 230 is shortened, the open time of the intake valve 110 or the exhaust valve 210 is shortened. That is, duration of the intake valve 110 or the exhaust valve 210 is shortened.

In addition, when the waveform width of the control signal is wide, the open amount of the servo valves 130 and 230 is increased, and thus the hydraulic pressure or hydraulic flow supplied to the intake valve 110 or the exhaust valve 210 through the servo valves 130 and 230 is increased and movement distances of the operation rods 124 and 224 of the actuators 120 and 220 are increased such that the open amount of intake valve 110 or the exhaust valve 210 is increased. That is, a lift of intake valve 110 or the exhaust valve 210 is increased.

On the contrary, when the intensity of the control signal is low, the open amount of servo valves 130 and 230 is decreased, and thus the hydraulic pressure or hydraulic flow supplied to the intake valve 110 or the exhaust valve 210 through the servo valves 130 and 230 is reduced and the movement distances of the operation rods 124 and 224 of the actuators 120 and 220 are shortened such that the open amount of intake valve 110 or the exhaust valve 210 is decreased. That is, a lift of the intake valve 110 or the exhaust valve 210 is reduced.

Meanwhile, the controller 50 determines actual positions of the intake valve 110 and the exhaust valve 210 from positions of the operation rods 124 and 224, sensed by the position sensors 140 and 240, and calculates a position error with the positions according to the control signal. The controller 50 compensates the control signal to make the position error zero and outputs the compensated control signal so as to perform accurate position control of the intake valve 110 and the exhaust valve 210.

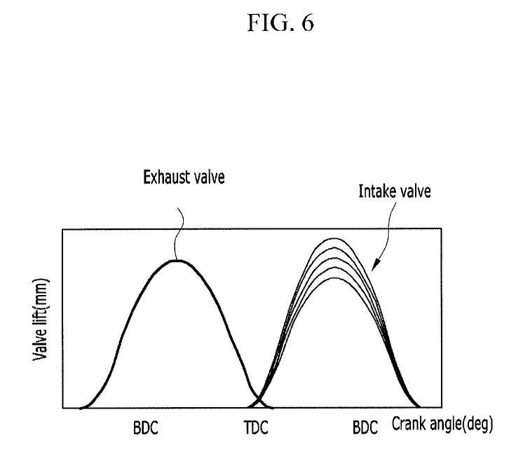

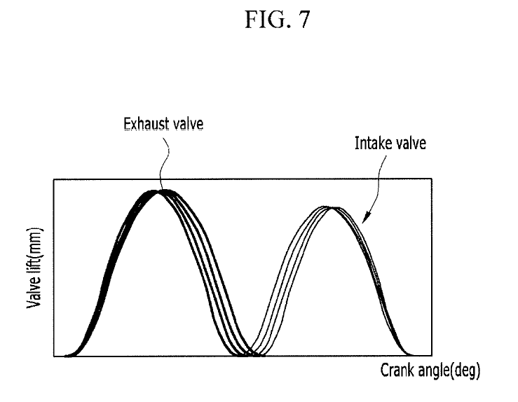

As described above, FIG. 3 to as shown in FIG. 7, the variable valve apparatus according to the exemplary embodiment of the present invention can control opening/closing timing, lift, overlap, and duration of the intake valve 110 and the exhaust valve 210 according to the control signal output from the controller 50.

In addition, since the valves or the open/close timing, lift, and duration of the valves are not controlled by a mechanical apparatus (i.e., a mechanical variable valve apparatus) including a camshaft, the structure of the variable valve apparatus according to the exemplary embodiment of the present invention can be simplified, and response speed becomes fast.

Further, since the open/close timing, lift, duration of the valves are controlled by the control signal output from the controller 50, the open/close timing, lift, duration of the valves and overlap of the intake valve 110 and the exhaust valve 210 can be variously implemented without an additional design modification, and manufacturing cost can be saved.

In addition, a position error between actual positions of the valves and positions according to the control signal is calculated by measuring the actual positions of the intake valve 110 and the exhaust valve 210, and the control signal is compensated to make the position error zero so that the intake valve 110 and the exhaust valve 210 can be precisely controlled.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. it is intended that the scope of the invention be defined by the Claims appended hereto and their equivalents.

What is claimed is:

1. A variable valve apparatus comprising:
a crank position sensor sensing a position of a crank shaft;
a plurality of valves selectively opening or closing a combustion chamber in a cylinder;
a hydraulic pump device supplying a hydraulic pressure or a hydraulic flow;
servo valves fluidically-connected to the hydraulic pump device and controlling the hydraulic pressure or the hydraulic flow supplied from the hydraulic pump device according to the position of the crank position, sensed by the crank position sensor;
actuators fluidically-connected to servo valves and operating the valves by the hydraulic pressure or the hydraulic flow supplied from the servo valves; and
a controller outputting a control signal controlling an open amount and an open time of the servo valves according to the position of the crank shaft.

2. The variable valve apparatus of claim 1, wherein the open amount and the open time of the servo valves are respectively controlled according to intensity and a waveform width of the control signal output from the controller.

3. The variable valve apparatus of claim 1, wherein the actuators comprise:
actuator housings to which the hydraulic pressure or the hydraulic flow is introduced through the servo valves; and
operation rods slidably provided in the actuator housings, operating according to the hydraulic pressure or the hydraulic flow introduced into the actuator housings, and respectively connected with the plurality of valves.

4. The variable valve apparatus of claim 3, further comprising a position sensor sensing positions of the operation rods of the actuators.

5. The variable valve apparatus of claim 4, wherein the controller compensates the control signal from the positions of the operation rods, sensed by the position sensor.

6. The variable valve apparatus of claim 5, wherein the controller determines a position error of the plurality of valves from the positions of the actuators, sensed by the position sensor and the position of the crank shaft, sensed by the crank position sensor, and outputs the control signal after making the position error zero.

7. The variable valve apparatus of claim 1, wherein the plurality of valves comprise:
an intake valve being selectively opened or closed for supplying air and fuel to the combustion chamber; and
an exhaust valve being selectively opened or closed to discharge exhaust gas generated from the combustion chamber.

8. The variable valve apparatus of claim 1, wherein the hydraulic pump device comprises:
a hydraulic storage storing oil;
a pump fluidically-connected to the hydraulic storage and the servo valves and pumping oil stored in the hydraulic storage; and
a hydraulic motor connected to the pump and operating the pump.
